(19) United States
(12) Patent Application Publication
(10) Pub. No.: US 2012/0097591 A1
(43) Pub. Date: Apr. 26, 2012

(54) Chromatography Apparatus

(76) Inventors: Wolfgang Berthold, Weggis (CH); Andrea Claudia Walter, Mittelbiberach (DE)

(21) Appl. No.: 13/202,500

(22) PCT Filed: Feb. 12, 2010
(86) PCT No.: PCT/EP2010/000875

§ 371 Date: Dec. 27, 2011

Related U.S. Application Data
(60) Provisional application No. 61/153,749, filed on Feb. 19, 2009.

(30) Foreign Application Priority Data
Feb. 19, 2009 (DE) 10 2009 009 703.1

(51) Int. Cl. B01D 15/22; B22F 7/02; B22F 3/105; B29C 35/08

(52) U.S. Cl. 210/198.3; 264/497; 419/7

(57) ABSTRACT

The invention relates to an apparatus for the chromatographic separation of a substance mixture in liquid form, comprising a stationary phase, wherein the stationary phase is configured in particular as a plate or plate-shaped body, consisting in particular of a porous solid, characterised in that the apparatus comprises at least one feed device for feeding a substance mixture, wherein the feed device comprises a plurality of feed openings and a plurality of feed lines and the feed openings are in particular disposed in one plane so that the length of the feed lines from a collecting feed line to at least a part of the plurality of feed openings is substantially the same.

The invention relates to an apparatus for the chromatographic separation of a substance mixture in liquid form, a module for the chromatographic separation of a substance mixture in liquid form, a chromatographic apparatus having at least one such module and a method for manufacturing a device having a plurality of feed and discharge openings for a chromatographic apparatus. In particular the invention relates to a chromatographic apparatus for the chromatographic separation of substance mixtures comprising biological molecules and molecules produced by biotechnology. Biological molecules are usually molecules from the natural environment, for example, from milk or tissue both of an animal and a vegetable nature. Molecules produced by biotechnology are preferably biopharmaceutical molecules, for example, lipids, proteins, nucleic acids or viruses.

Chromatographic apparatuses in particular for biopharmaceutical production have already been known for a long time, these however usually being based on a column-like structure. A disadvantage with these chromatographic apparatuses having a column-like structure was that the product quality was certainly reached as a result of the high precision but a change of the production volume (so-called scale up) was not possible in a simple manner because comprehensives measurements were always necessary for this purpose before commissioning the changed process volume.

A column-like chromatographic apparatus is known, for example, from U.S. Pat. No. 7,390,408. In the chromatographic apparatuses for biopharmaceutical production which are configured in column form, these are generally filled with particulate chromatographic media as described, for example, in U.S. Pat. No. 7,390,408. A disadvantage of the column-like chromatographic apparatus as is known from U.S. Pat. No. 7,390,408, for example is that large column diameters and/or column heights can only be achieved with a very high manufacturing effort. Furthermore, the high pressures of 3 to 5 bar require a very high precision during manufacture. The height of the column in the chromatography process is substantially limited by the compaction of the particles of the particulate matrix and the increasing process pressure. It is also disadvantageous that a change of the process volume was expensive.

In addition to particulate chromatographic matrices as described, for example, in U.S. Pat. No. 7,390,408, chromatographic apparatuses have also become known in which porous solids can be used instead of particulate matrices. Porous solid matrices are however limited in that during the manufacturing process for the porous solid matrices which are generally polymerisation products, the layer thickness of the porous solid is limited by the inhomogeneity of the pore distribution which occurs in the polymerisation process due to the evolution of heat.

A chromatographic apparatus has become known from U.S. Pat. No. 5,139,680, which comprises a chromatographic packing which can be configured in different ways as a stationary phase, for example, also in plate or block form. No information is given in U.S. Pat. No. 5,139,680 as to the type of feed of the substance mixture to be separated to the stationary phase. In particular, no information is given as to how the process volume can be changed without comprehensive measurements before commissioning the changed process volume.

DE 1,517,944 discloses a separating apparatus and a separating method in which a filler material serves as one of the phases or as a support for one of the phases. The filler material according to DE 1,517,944 comprises spherical particles which are poured into a column of a chromatographic apparatus. The stationary phase therefore comprises a particulate matrix. The individual spherical particles can be subsequently compacted by sintering after filling the chromatographic column. The intermediate spaces between the individual spherical particles can also be filled with a polymer as filler material. Strips of plastic foams which can be installed between two plates are also known from DE 1,517,944. A stationary phase which itself as a plate is obtained from a polymer, in particular from a polymer obtained by liquid phase polymerisation having a very homogeneously distributed porosity has not become known from DE 1,517,944. On the contrary, the apparatus according to DE 1,517,944 comprises an apparatus for column chromatography. DE 1,517,944 also gives no information on the arrangement of the distribution device for supplying the substance mixture to be separated to the particulate matrix.

DE 43 43 358 discloses thermally stable filter elements in plate-shaped form which comprise activated charcoal beads and were obtained by hardening and drying. In this document no statements are made on the supply of the substance mixture to the particulate matrix, in particular not as to how a simple increase in the process volume can be achieved.

A separating device for liquid and gaseous media has become known from U.S. Pat. No. 4,775,484 in which the absorbing material is configured as a solid, porous block. However, no material is specified for this and also U.S. Pat. No. 4,775,484 provides no information as to how a uniform feed of the substance mixture to the porous block can be achieved.

It is therefore the object of the invention according to a first aspect, to provide a chromatographic apparatus, in particular for the separation of biopharmaceutical products such as, for example, proteins, nucleic acids, virus particles, which obviates the disadvantages of the prior art and in particular provides large volumes for a chromatographic separation. In a further aspect of the invention, the chromatographic apparatus should be configured so that it is in particular characterised by a particularly uniform liquid distribution. Furthermore, a method for manufacturing a distribution device for a chromatographic apparatus should be provided, which is characterised by a high flexibility and a simple process control. In particular, it should be possible to very easily change the process volume of the apparatus.

According to the invention, in order to solve the first aspect of the invention an apparatus for chromatographic separation is provided in which the stationary phase comprises at least one porous solid, in contrast to a bulk material in apparatuses according to the prior art, which is configured to be plate-shaped, wherein the plate formed by the solid is characterised by an area and a layer thickness. The solid itself is a porous solid matrix having a pore distribution which is as homogeneous as possible and which is suitable for chromatographic separation. In principle, the porous solid can be a largely homogeneous polymerisate or consist of layered membranes. PMMA is preferred as a homogeneous polymerisate, cellulose membranes in the case of membranes. It is particularly preferred if the polymerisate is obtained by polymerisation from monomers in the liquid phase. PMMA for example is particularly preferred.

As a result of the completely different geometry of the stationary phase as a plate, in contrast to the bulk material or particulate matrix, the space requirement of the chromatographic apparatus is reduced appreciably and the weight is reduced. In particular, this is possible since the solid can be layered or combined in modules and thus the chromatographic apparatus provides chromatographic volumes particularly vertically. The plate-shaped porous solid allows the use of large chromatographic volumes despite limited layer thickness. A further advantage is that the chromatographic apparatus having a plate-shaped porous solid comprises no movable parts such as, for example, a chromatographic column which is filled with a particulate matrix and in which the particulate matrix must be compacted, for example, by a stamp.

The layer thickness of the plates is preferably 0.5 to 15 cm, preferably between 1 cm and 5 cm. Such a layer thickness ensures that the solid produced by polymerisation, in particular by liquid polymerisation, is homogeneously polymerised and has a sufficient homogeneity of the pore distribution for chromatography. The areas of a plate which can be produced by polymerisation range from a size of 1×1 cm to 100×200 cm, in particular of 10×20 cm to 40×80 cm, that is of areas of 4 cm² to 20,000 cm², preferably 200 cm² to 3,200 cm². By arranging a plurality of such plates one above the other, process volumes, for example, of 2,000 l, for example but not exclusively with a concentration of the substance to be separated of 5 g/l and more can be achieved. Process volume is understood to be the volume of liquid which is sent across the chromatographic apparatus until the substances bound in the porous pores are released, for example, by changing the buffer or the conductivity and removed in the eluate. The process volume is substantially determined by the required amount of chromatographing substance in the substance mixture and corresponds, for example, to the fermentation volume of the production fermenter in a biopharmaceutical production using, for example, mammalian cells, micro-organisms. The chromatographic volume on the other hand is determined by the total surface area which is available in the porous solid.

The porous solid of the plate-shaped stationary matrix is preferably made of a polymer material having a homogeneously distributed porosity. In particular an acrylate, in particular a polymethyl methacrylate (PMMA) is used as the polymer material here. The porous plate-shaped solids are particularly preferably obtained by a liquid polymerisation of monomers. Sintered materials or crystals would also be possible if these are combined into a block. Homogeneously distributed means that the pores in the polymer material are homogeneously distributed. For the most part, preferably more than 95%, in particular more than 80%, of the pores are interconnected and thus form a largely continuous cavity.

In order to load the plate-shaped stationary phases as uniformly as possible with the substance mixtures to be separated in liquid form, a device is provided having a plurality of feed openings which has a plurality of feed lines for feeding the substance mixture to be separated. This device is also designated as feed device. The apparatus according to the invention is preferably configured such that the feed openings are distributed in such a manner over the plate surface that the entire plate surface can be loaded with substance mixture to be separated via the feed openings. A uniform loading is particularly preferably achieved by the feed opening being configured, for example, in funnel form, e.g. as a cone, wherein the outlet surface of the cone or truncated cone provides the substance mixture on a partial region of the surface of the porous solid to be loaded. In particular, the feed openings are arranged over the surface of the porous solid such that the outlet surface assigned to each cone in total for all cones covers the entire surface of the porous solid to be loaded. For this purpose the individual feed openings are arranged regularly, in particular in rows and columns. An embodiment in which a partial region of the porous solid, as described above, is loaded with the substance mixture to be separated enables all the relevant process data for the chromatography to be determined for this partial region. As a result of the regular structure of the feed openings in rows and columns, the relevant process data determined for one feed opening can be transferred to all the feed openings. By this means a linear scale-up for any process volumes is possible in a simple manner.

The apparatus preferably further comprises a device having a plurality of discharge openings which is used to discharge the flow and/or the eluate and which is designated as discharge device. Flow is understood in chromatography and in the present application as the liquid which runs unbound through the porous solid. Eluate is understood as the liquid which is obtained when the bound substance or the bound substances in the porous solid is or are released again. For example, it would be possible to load the plate-shaped solid at a specific pH and/or specific conductivity, for example, a pH of 7 or a conductivity of 2 to 10 millisiemens cm⁻¹. At this pH specific substances bind to the surfaces of the porous solid, for example, to the surfaces provided in the pores. The given parameters, pH, conductivity are merely example parameters and not restricted hereto. The parameters are substantially dependent on the functional groups which are applied to the pore surface and interact with the substance mixture to be separated.

If the pH and/or the conductivity are now changed, for example, by adding a buffer solution, a so-called elution buffer, the substances bound in the solid are desorbed. The liquid containing the desorbed substances is then designated as eluate. The eluate therefore contains the product. It is generally the case when operating a chromatographic apparatus that the substance to be separated, which is contained in the substance mixture, is reversibly bound to the surfaces of the porous solid, that is, the substances are initially adsorbed on the surfaces of the porous solid. By changing the pH and/or the conductivity, the substances are then desorbed. Apart from diffusion phenomena, the adsorption/desorption takes place almost 100% reversibly. In a special case the apparatus can also be operated in flow chromatography. In such a case the chromatographic apparatus is loaded with product liquid. Impurities in the product are then bound in the porous matrix. After running through the porous solid, in flow chromatography purified product is obtained in the flow. The impurities retained in the porous matrix can be released subsequently from the porous solid, by adding appropriate solutions, for example, buffer. The chromatographic device according to the invention is also suitable for this purpose.

In order to achieve a high homogeneity in the loading of the plate-shaped stationary phase, in a first measure it is provided that according to the invention a substantially identical inflow is provided at each of the feed openings which are distributed regularly over the entire surface of the plate-shaped body, e.g. in columns and row. A first measure to achieve a largely uniform inflow is to configure the length of the feed line to the respective individual feed opening from a collecting feed line to be at least in part substantially the same length. By this means it is prevented, for example, that as in a linear feed along a single collecting feed or discharge line, a pressure drop exists and therefore a uniform flow is not achieved at all feed openings. Preferably substantially the same length of the feed line is achieved if feed lines in the plane have a dichotomous branching structure. A dichotomous branching structure is characterised by a repeated fork-shaped branching. Such a dichotomous branching structure is also a fractal structure. Such fractal structures are known, for example from U.S. Pat. No. 4,537,217, whose disclosure content is included in its full scope in the present application.

In order to achieve a particularly uniform distribution of a substance mixture to be supplied via a feed opening over the surface, it is advantageous if the feed opening is configured in such a manner that a uniform distribution of the supplied substance onto the surface of the solid takes place over the entire area of the feed opening.

In a particularly preferred embodiment, the substance mixture is supplied from the feed line via an outlet opening substantially horizontally to the surface of the plate-shaped solid into the feed opening. A baffle surface lies opposite the outlet opening which opens substantially horizontally into the feed opening. The substance mixture emerging horizontally from the outlet opening impinges upon the baffle surface and is thereby deflected. As a result of the deflection, the liquid stream introduced in the feed opening in the form of the substance mixture is swirled or set in rotation so that the substance mixture penetrates into the surface of the plate-shaped body over the entire area of the feed opening, i.e. distributed over the entire outlet surface of the, for example, conical feed opening. As a result of this measure, a largely uniform distribution of the liquid flow introduced into the feed opening is achieved in a surprising manner over the area of the feed opening. This cannot be ensured under all circumstances in the case of a non-horizontal connection of the feed line to the feed opening. If the feed lines are, for example, introduced into the feed opening perpendicular to the surface of the plate-shaped body, at high flow rates there is the risk that the liquid flow will no longer be distributed uniformly in the space enveloped by the respective feed opening, i.e. over the outlet surface of the feed opening and therefore no longer penetrates uniformly into the surface of the solid or chromatographic body covered by the respective feed opening but on the contrary penetrates into the porous solid or chromatographic body over a limited area.

The individual feed openings are preferably but not necessarily configured to be conical or as a cone. The individual feed openings configured as cones are particularly preferably arranged in such a manner that conical cavities overlap. This ensures on the one hand that the entire area of the plate-shaped body is covered, on the other hand, an exchange of the supplied or discharged substance mixture or eluate can be achieved through the connection of the individual conical cavities. The connection of the individual feed openings or cones results in a pressure equalization of the individual interconnected cones. If all the cones used to load an area, for example, the surface of a solid, are interconnected, a pressure equalization can be achieved over the entire area to be loaded. The pressure is therefore substantially the same over the entire surface.

In a further developed embodiment of the invention, the individual feed or discharge lines, in particular in a dichotomous branching structure, are not branched at an angle of approximately 90° as in U.S. Pat. No. 7,390,408, for example, but are configured in such a manner that a largely guided liquid flow is provided. The formation of turbulence in the liquid flow is largely reduced by such a configuration. Less energy is then required for guiding the liquid or the substance mixture. Another advantage is that such a feed is gentle on the product. The branches or feed lines are preferably configured to be rounded for this purpose.

In order to achieve a uniform liquid distribution over the entire surface taking into account the hydrodynamic properties of a liquid flow in regard to its flow profile, in particular from temporal aspects, i.e. in order to provide the same amount of liquid substantially at the same time at all feed openings, in a first advantageous embodiment it can be provided to provide the individual feed lines with a guiding device or deflecting devices. Such guiding or deflecting devices are, for example, baffles or webs which are inserted in the feed line and deflect the liquid flow guided through the line. The deflecting devices, for example, the plastic webs together with the feed lines, are particularly preferably made from a layer of powdered plastic. Alternatively or additionally to the measure described previously comprising guiding devices, in a second advantageous embodiment it can be provided that the feed lines are configured in their geometry in such a manner that substantially the same amount of liquid is supplied to the feed opening(s). For this purpose, the feed lines, for example, do not have a uniform cross-section but, for example, thickened sections or thinned sections.

As a result of the measure described previously, it can be achieved, for example, that the deviation of the amount of liquid supplied to the surface after a certain time is no more than ±30%, in particular no more than ±20%, preferably no more than ±10% from a uniform distribution of the supplied quantity of liquid over the surface.

In addition to the feed openings, the discharge openings can also be specially configured, e.g. conical.

It is particularly preferred if, in a further development of the invention, the apparatus has a seal which surrounds the plate-shaped porous solid through which the substance mixture to be separated is guided. The seal surrounding the plate-shaped porous solid and which ensures a liquid-tight termination between the devices for feeding or the feed plates and the devices for discharging or the discharge plates as well as the porous solid, can be a device, for example, a frame which is connected to the feed plate or the discharge plate. A bracing apparatus can be provided in the frame surrounding the seal to achieve a clamping effect on the circumferential seal. The seal and the frame can preferably be configured so that the seal is configured to be wedge-shaped and adapted to the frame for sealing.

This results in an optimal seal and furthermore in that the contact pressure of frame and seal can be varied very simply.

In a particularly preferred embodiment, both the feed plate and the discharge plate which each comprise the plurality of feed openings or discharge openings have collecting feed and discharge lines which are disposed on the same side of the plate. The collecting feed and the collecting discharge lines can have connectors which can be connected to a valve.

It is particularly preferred if a module is provided for use in a chromatographic apparatus which comprises a stationary phase which is configured as a plate or plate-shaped body preferably consisting of a porous solid as well as a first apparatus for supplying a substance mixture having a plurality of feed openings and a second plate-shaped body having a plurality of discharge openings. The plate having the plurality of feed openings and the plate having the plurality of discharge openings are substantially configured so that due to the regular arrangement of the plurality of feed or discharge openings, for example, in rows and columns, substantially the same surface of the plate-shaped body is covered. The length of the feed lines to the individual feed openings or the length of the discharge line to the individual discharge openings from the collecting feed or discharge line is determined so that it is substantially the same. The collecting feed line and the collecting discharge line have connectors laterally on the module. These connectors are preferably arranged on the same side of the module. The module can then be configured as a disposable article and inserted in a holding device of a chromatographic apparatus.

All the explanations made previously relating to the apparatus for chromatographic separation also apply to the modules having feed lines and feed openings. In particular, the feed lines and the feed openings can, as described previously, be configured advantageously, for example, provided with guiding devices.

In the modules, the feed device and also the discharge device can be clamped between two cover plates, which are preferably formed from metal, in particular from stainless steel. Alternatively or additionally to such a configuration, it can be provided that a self-supporting honeycomb structure made of a polymer material is provided. The honeycomb structure and the feed or discharge device can be designed as different components or as a single component. By this means a considerable weight reduction can be achieved with the same stability. The individual modules can be configured to be wedge-shaped or conical whereby a clamping effect is achieved when stacking a plurality of modules one above the other. In particular, such an embodiment has the advantage that when stacking a plurality of modules one above the other, the modules abut flush against the likewise wedge-shaped surfaces of the holding device. As a result, a screwing of the cover plates to absorb the pressure produced during the chromatography can be dispensed with, on the contrary the pressure is applied from the wedge-shaped surfaces.

The holding device itself comprises a module feed and a module discharge line which supply all the modules connected to the module feed and discharge line.

In this way, it is possible to vary the system in its flow volume over a large range.

In addition to the chromatographic apparatus, the invention also provides a method for manufacturing a device having a plurality of feed and discharge lines for such a chromatographic apparatus.

The method according to the invention comprises a manufacturing method in which the plates with feed openings and feed lines are produced directly, for example, on the basis of electronic data using a laser sintering technique. It is also possible to fabricate the plates having the honeycomb structure alone or together with the plates having the feed openings and feed lines. Furthermore, it is possible to produce the guiding devices together with the feed openings or line and/or the honeycomb plate. In the method firstly a layer of powdered plastic or metal is applied. This layer is then selectively fused and solidified, for example, with the aid of electromagnetic radiation provided by a laser. After the layer has been treated, a layer of powdered plastic or metal is again applied and this is then treated again using the laser. The fabrication of the layers and the selective treatment is accomplished sequentially for example by means of a laser until the entire workpiece, here the plate having feed lines and feed openings and/or the honeycomb structure and/or guiding devices or the plate having discharge lines and discharge openings, is produced.

It is advantageous with such a method that it is highly flexible and in particular does not require forming tools. Any three-dimensional structures can also be produced with such a method.

It is particularly advantageous if the data used to control the laser are computer data, wherein the computer data characterise the device.

The invention will be disclosed in detail hereinafter with reference to exemplary embodiments.

In the figures:

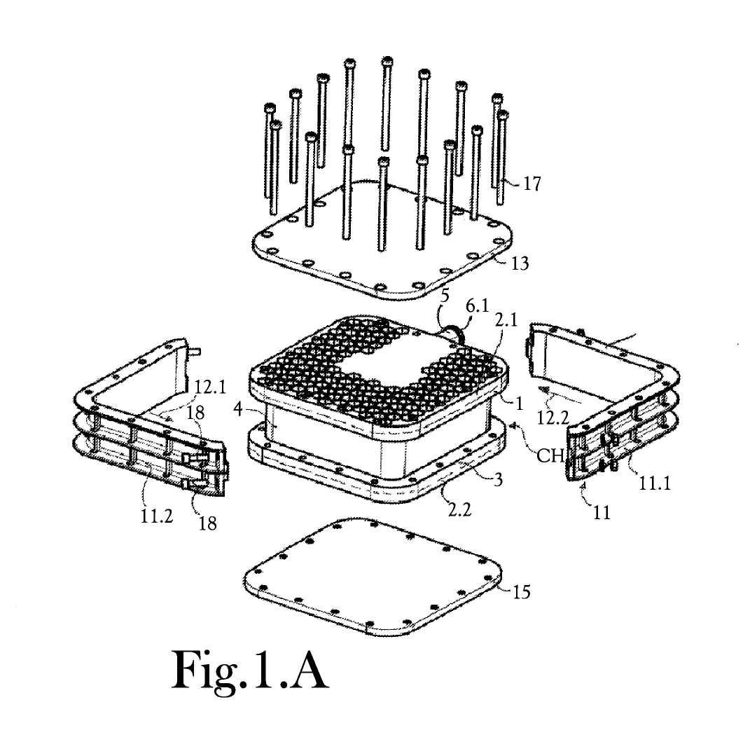

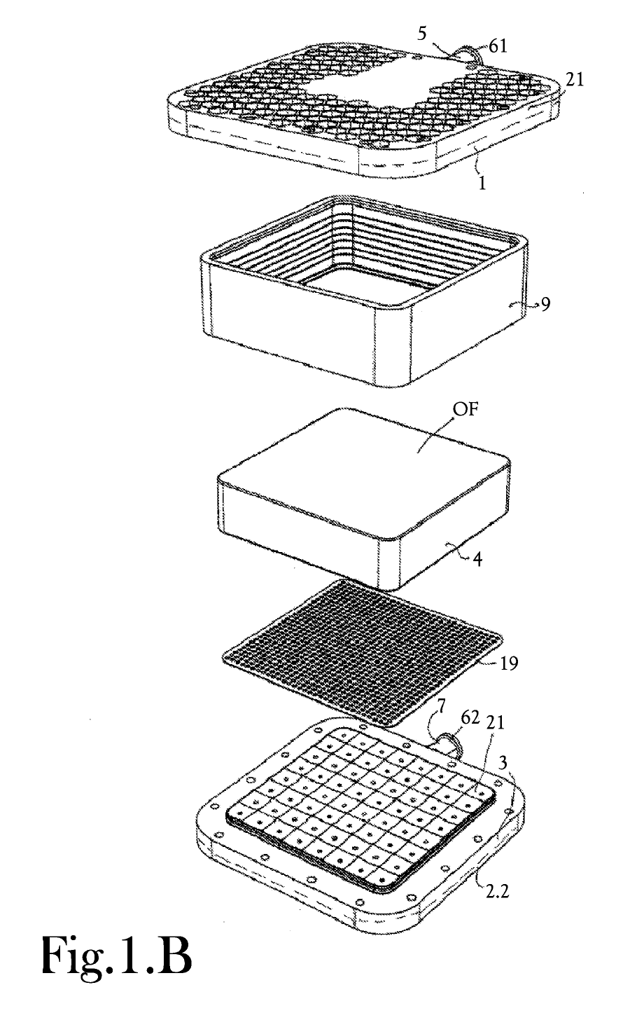

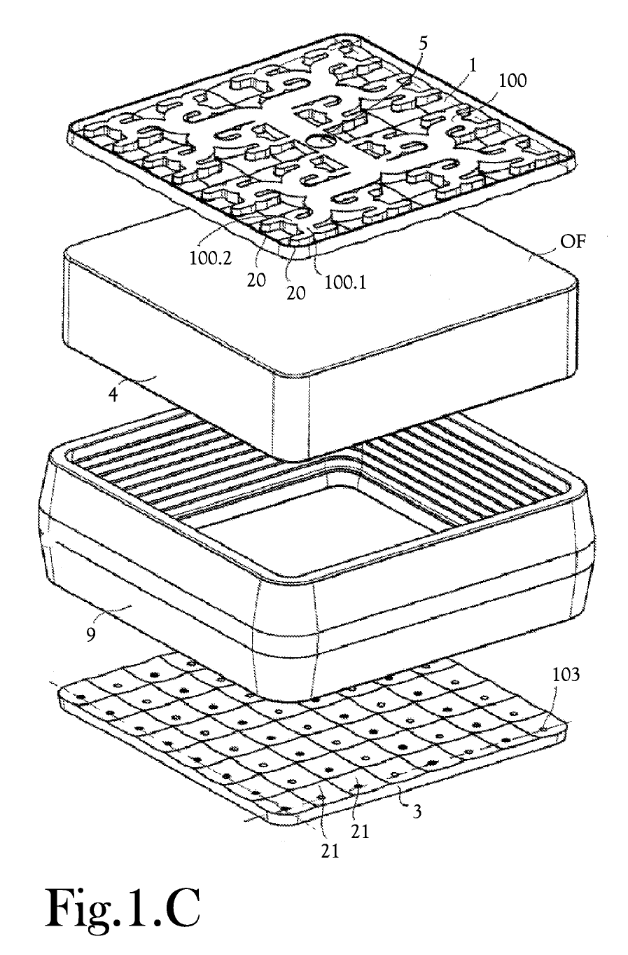

FIG. 1a shows the fundamental structure of a chromatographic apparatus according to the invention, in particular a module with cover plates;

FIG. 1b shows a detailed structure of an apparatus according to FIG. 1a with a sealing element and honeycomb plate as reinforcing element;

FIG. 1c shows the detailed structure of an apparatus according to FIG. 1a with a sealing element and view of the feed lines;

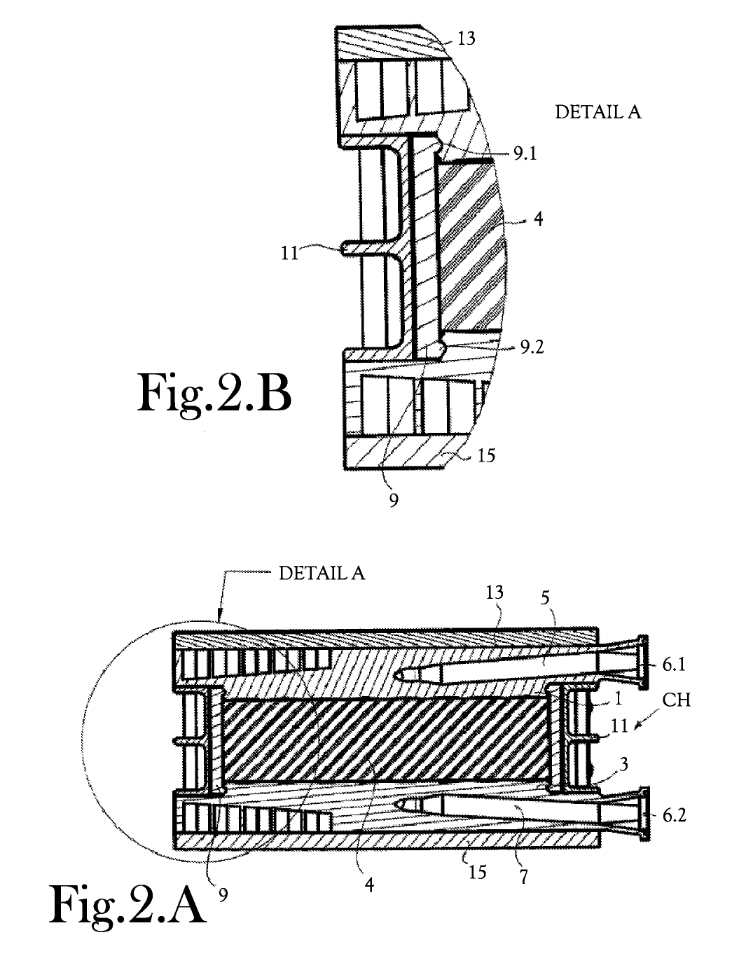

FIG. 2a-2b shows a section through a chromatographic apparatus according to the invention, in particular a detailed view of the sealing element

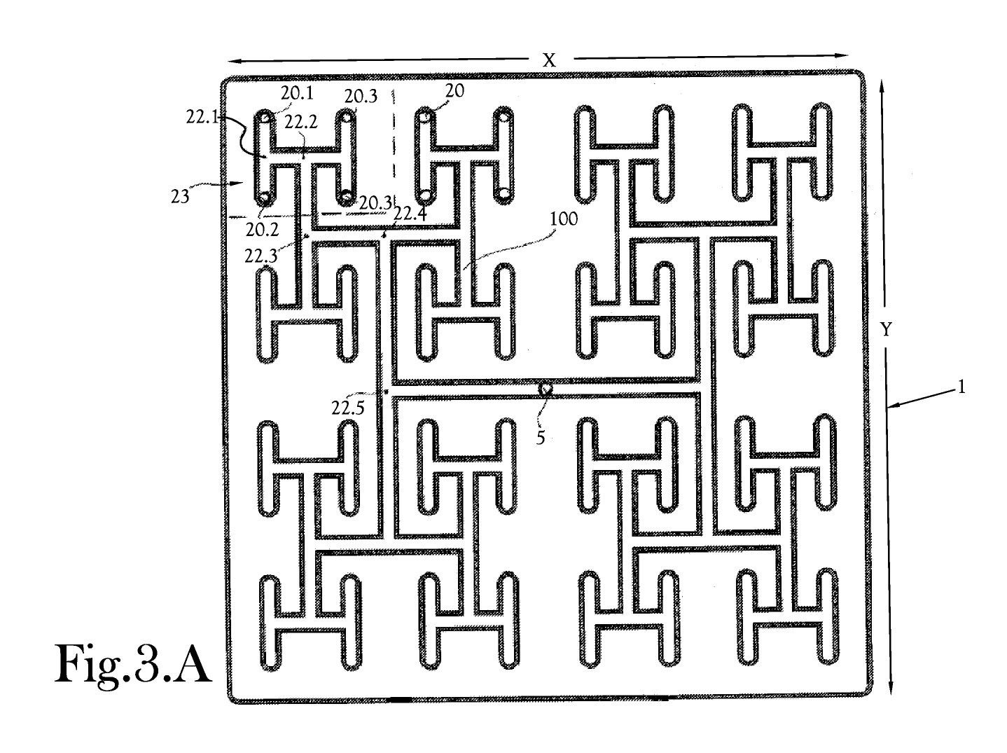

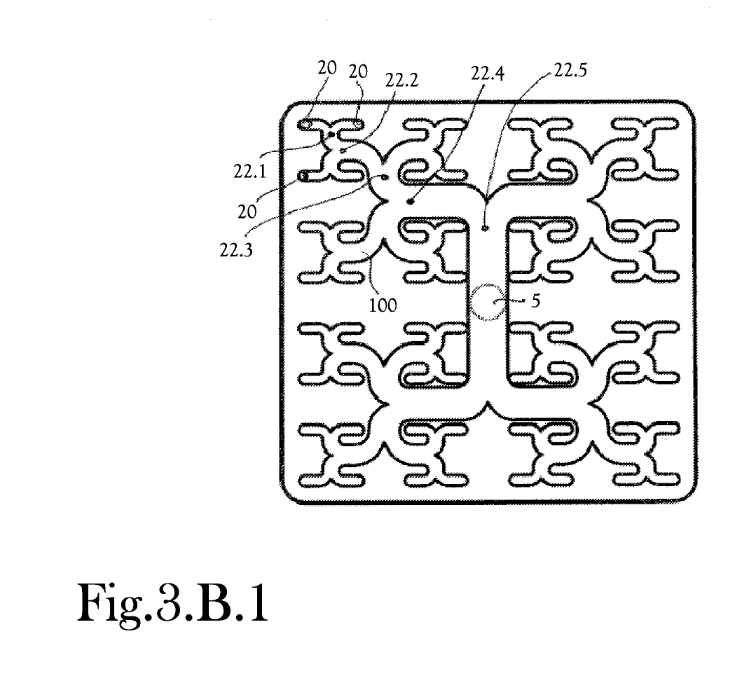

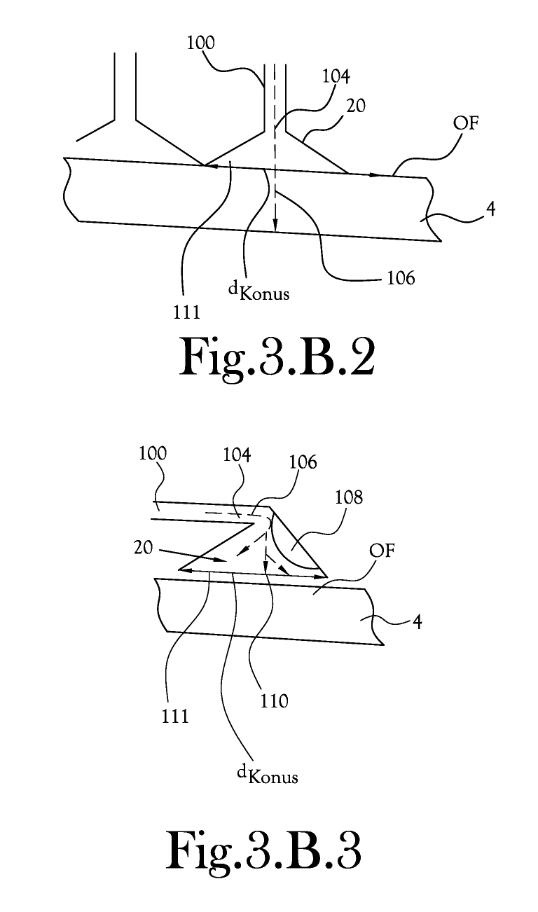

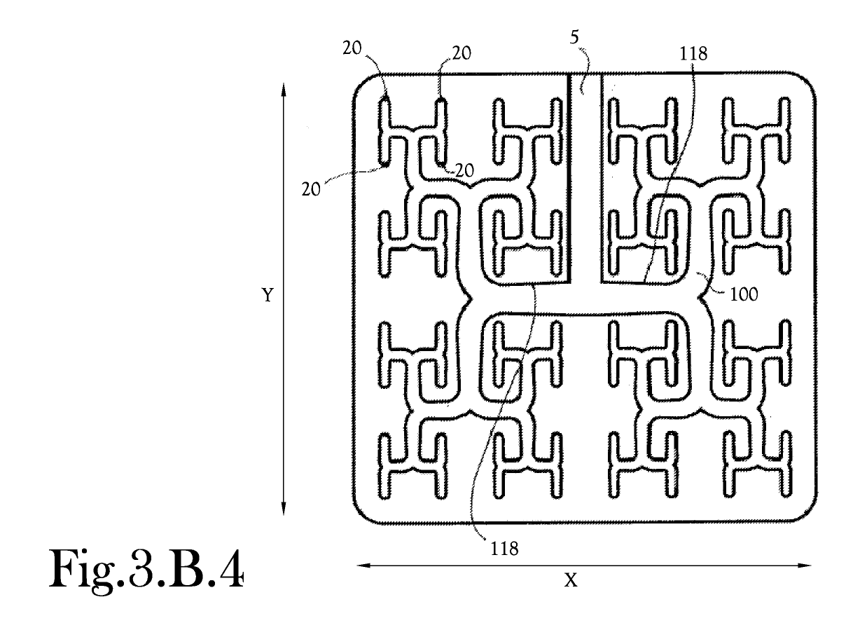

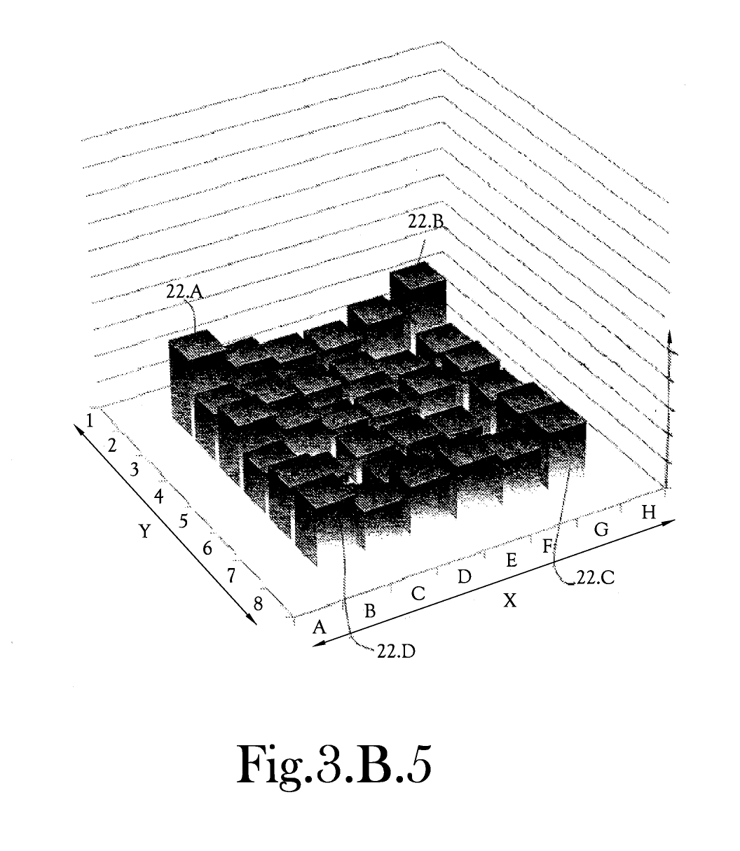

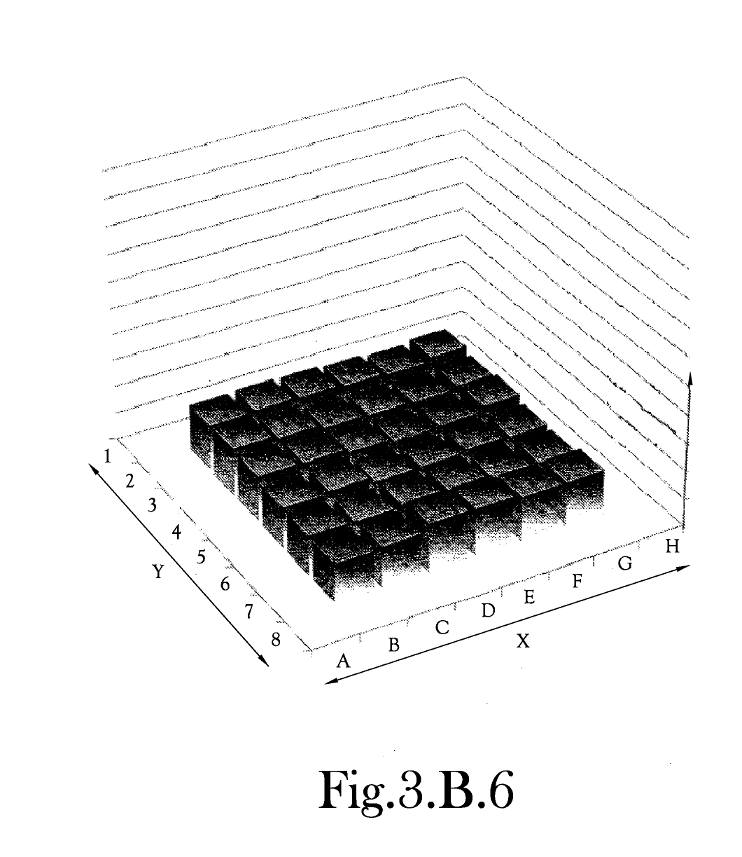

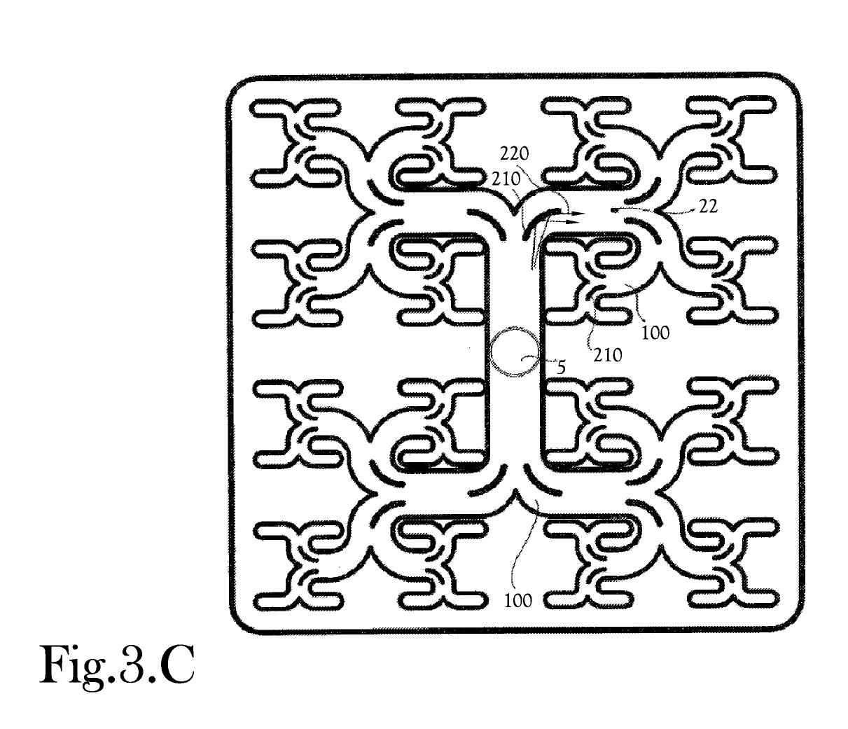

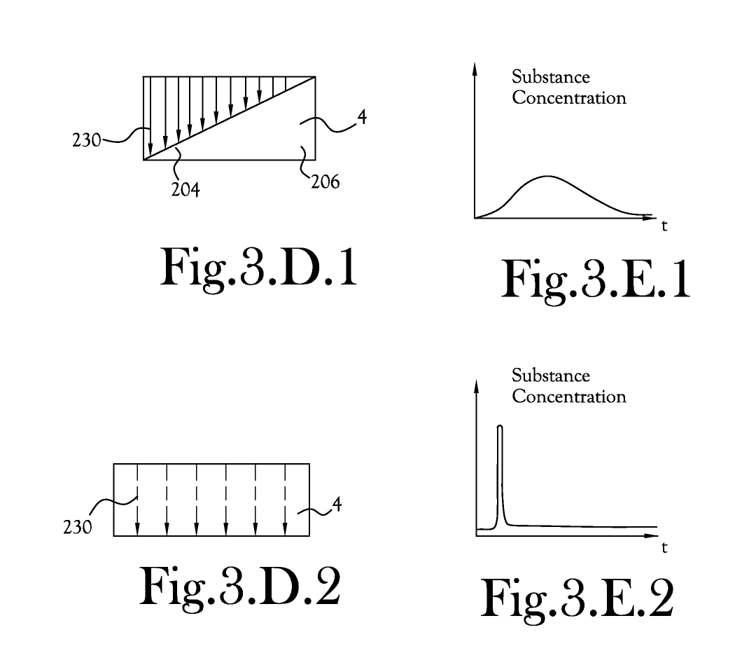

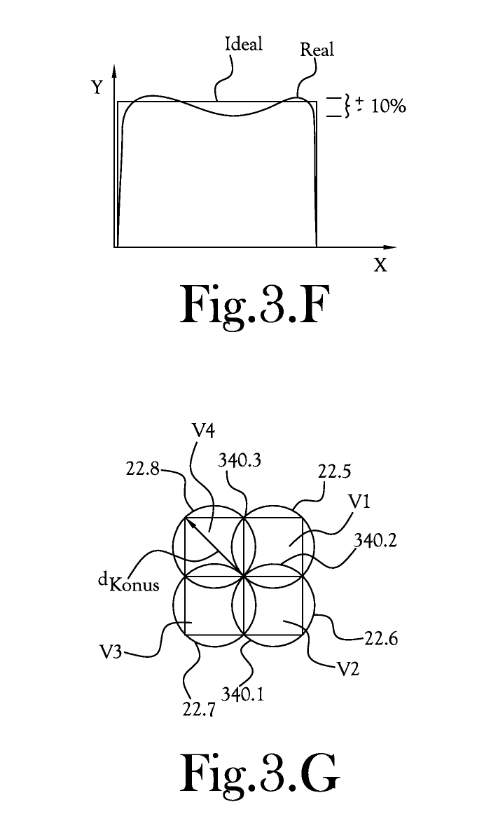

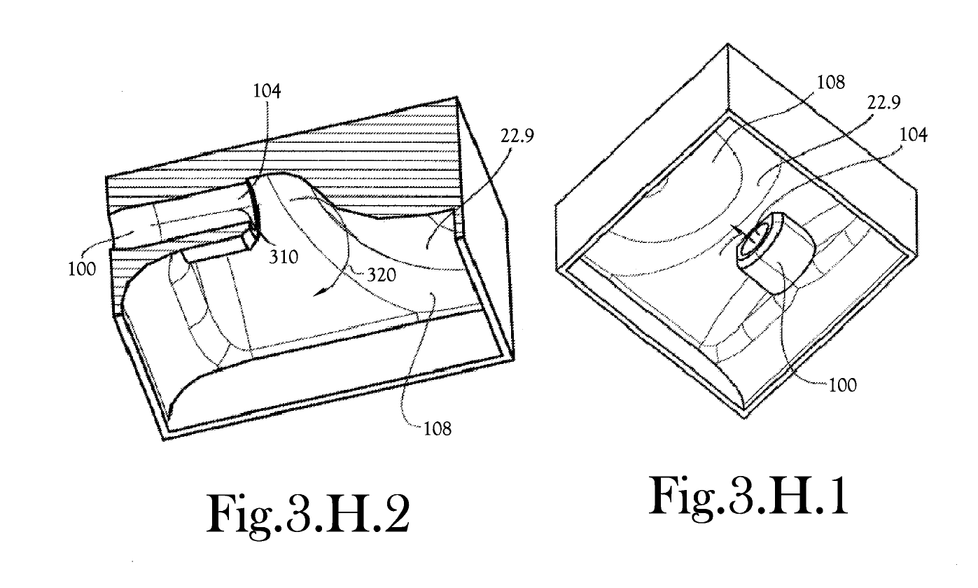

FIG. 3a shows a plan view of a feed device with dichotomous branching structure;

FIG. 3b.1-3b.4 shows a plan view of the a feed device having a dichotomous branching structure and rounded feed lines as well as a detailed view of the feed openings assigned to the feed lines;

FIG. 3b5-3b6 shows the amount of liquid after the same time at different feed/discharge openings;

FIG. 3c shows a plan view of a feed device with guiding devices;

FIG. 3d.1-3e.2 shows the elution volume for a device with and without a dichotomous branching structure of the feed lines as well as the resulting temporal substance concentration;

FIG. 3f shows the ideal loading of the porous solid after a time t and the actual loading, wherein the feed line has guiding devices

FIG. 3g shows a section through the plane of the feed plate or discharge plate in the area of the superposed cones;

FIG. 3h1-3h2 shows a feed opening with horizontal introduction of the feed line;

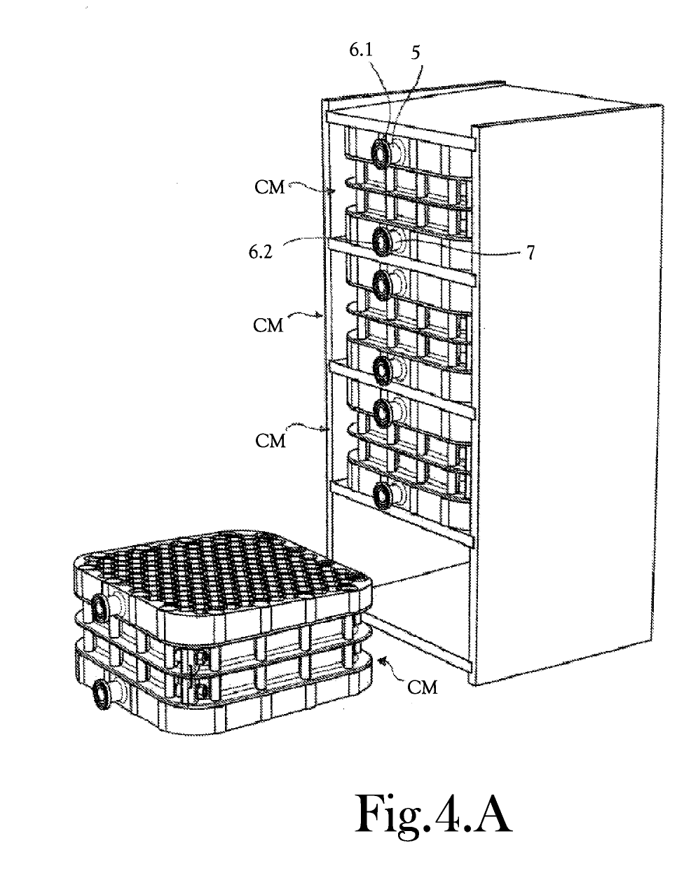

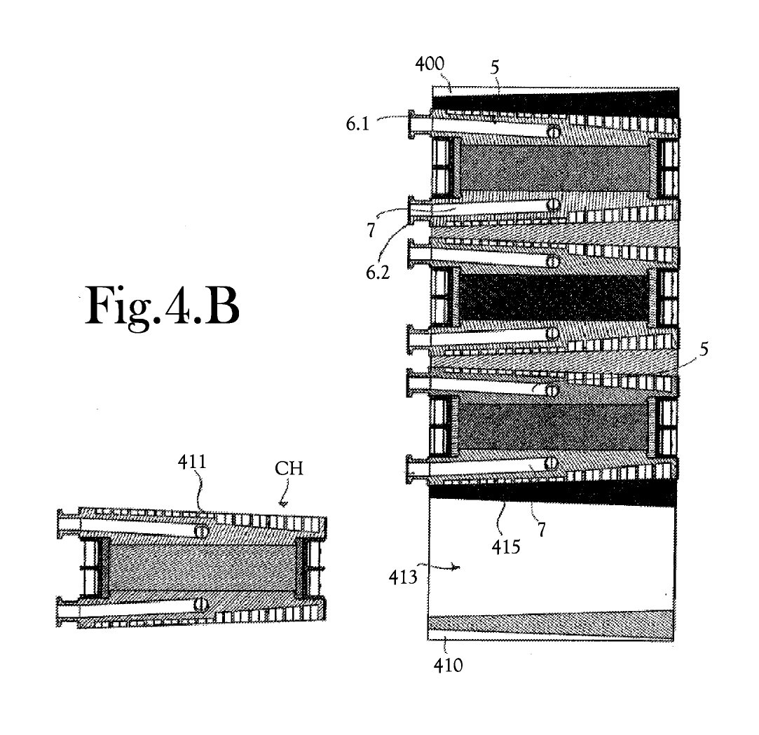

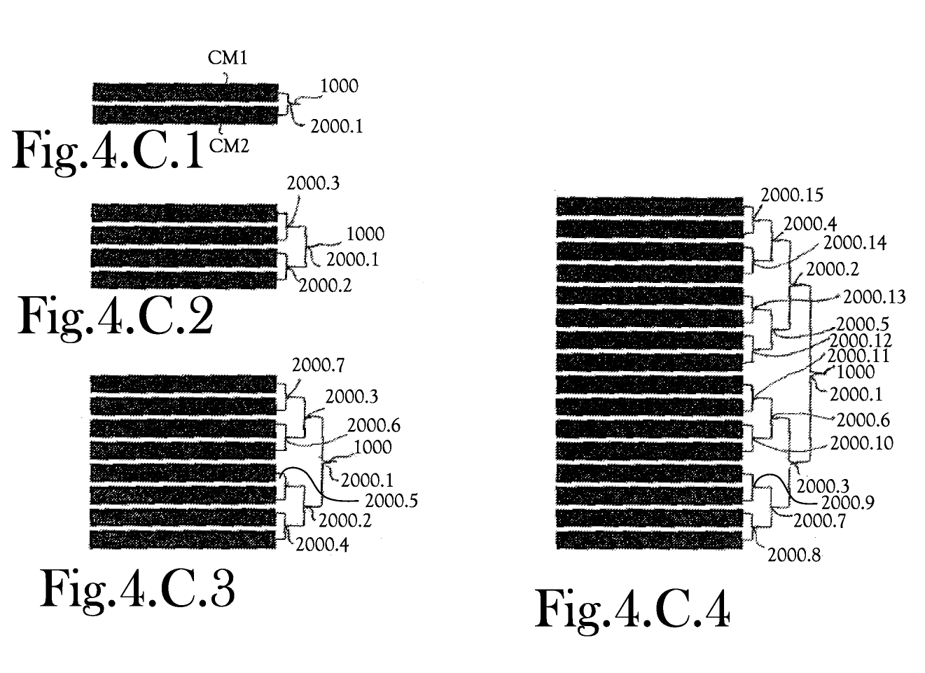

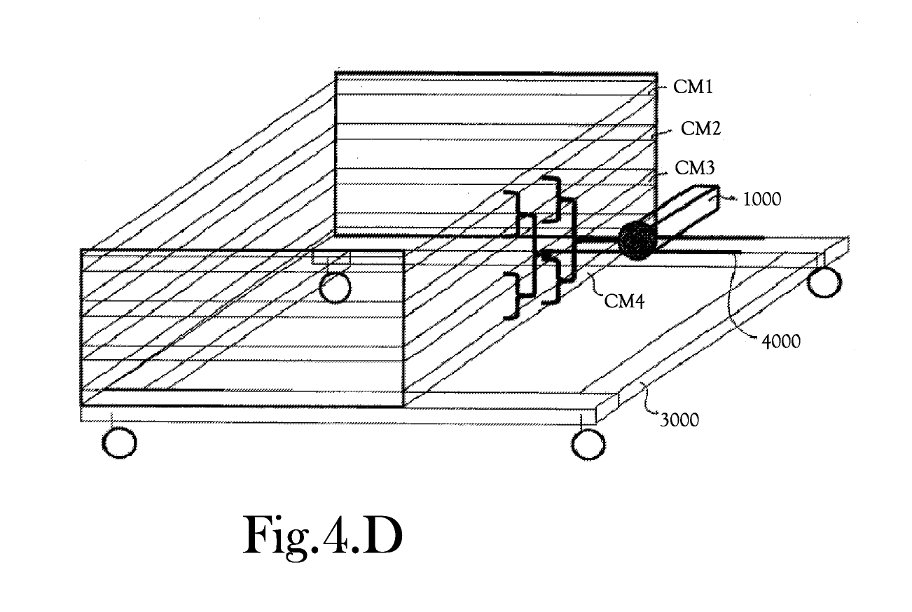

FIG. 4a shows a view of a chromatographic apparatus comprising a stack of four modules;

FIG. 4b shows a section through the stack according to FIG. 4a, wherein the honeycomb plates of the individual modules have wedge surfaces.

FIG. 4c.1-4c.4 shows a stack of several modules with feed line system, the feed line system being dichotomously branched.

FIG. 4d shows a mobile device with 4 modules

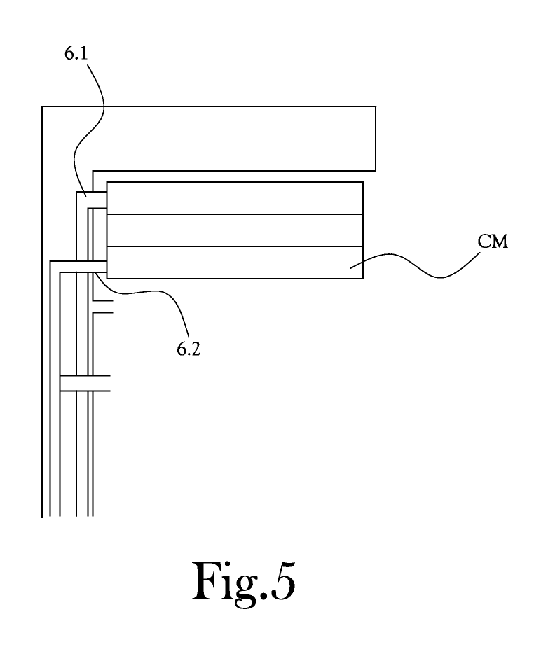

FIG. 5 shows a holding device.

FIG. 1a shows a first embodiment of a fundamental structure of a chromatographic apparatus or chromatographic module CM, comprising a feed line 1 for supplying a substance mixture, which is designed in the form of a distribution plate, a discharge device 3 for discharging a substance mixture and a plate-shaped porous solid matrix 4 located between feed and discharge device. In order to configure the feed or discharge device to be stable with low weight, in the embodiment shown, these are combined with respectively one honeycomb structure 2.1, 2.2 to form a single component. This is advantageous but in no way compulsory. FIG. 1a merely shows a plan view of the honeycomb structure. The regular arrangement of the feed or discharge openings and the branching structure of the feed or discharge lines to the individual feed or discharge openings in shown in FIGS. 1b and 1c, respectively. Further shown in FIG. 1a is the collecting feed line 5 for supplying the substance mixture to be chromatographed. The discharge device 3 comprises a collecting discharge line (not shown) for discharging the flow or eluate from the discharge device 3. Both the feed device 1 for supplying the substance mixture having a plurality of feed openings and the discharge device 3 having a plurality of discharge openings are configured in the present case in plate form in the same way as the solid matrix 4. The porous solid 4 is preferably produced by means of a polymerisation process. A homogeneous polymerisation which leads to a sufficient homogeneity of the pore distribution is ensured if the layer thickness of the solid plates is in the range of 0.5 to 15 cm, preferably between 1 cm and 5 cm.

The connection of the collecting feed line 5 or the collecting discharge line (not shown) is preferably made using connecting pieces available on the market as tri-clamps to a connector 6.1. This allows the modules to be manufactured for all commercially available connections. Alternatively the connection of the collecting feed line 5 or the collecting discharge line can also be executed in other commercially available forms of connection.

The collecting feed line or the collecting discharge line is branched as shown in detail in FIGS. 1c and 3a-3c in the form of a dichotomous branching structure. This type of structure of the feed or discharge line ensures that the length of the feed line from the common feed point, that is the connector 6.1 of the collecting feed line 5 to each individual one of the plurality of feed openings, is substantially the same length.

The porous solid 4 through which the liquid to be chromatographed is dispatched is surrounded by a circumferential seal 9 (shown in FIG. 1b and FIG. 1c), for example, a silicone seal, in order to prevent the liquid to be chromatographed from escaping from the porous solid. In the embodiment shown the seal is placed around the plate-shaped body 4. In the embodiment shown the feed device 1 with feed openings and the discharge device 3 with discharge openings are inserted between two cover plates 13, 15. The cover plates 13, 15 are screwed to one another. The screwing is accomplished by means of screws 17 which are screwed into the cover plates 13, 15 covering the feed and the discharge plates 1, 3. Although cover plates 13, 15 are shown in the embodiment in FIG. 1a, this is merely one possible embodiment. Slide-in modules can also be designed without cover plates as shown hereinafter. Tightness at a process pressure of 3 to 4 bar is then ensured by the total surface abutment of the wedge surfaces. The porous solid and the seal are surrounded by a frame 11.

In the embodiment shown the frame 11 is configured in two parts with a first frame part 11.1 and a second frame part 11.2. The frame parts 11.1, 11.2 can be interconnected by screws 18. By tightening the screws, the frame parts can be displaced in the directions 12.1, 12.2 so that a clamping action is achieved, for example, on the seal. Advantageously in the embodiment shown according to FIG. 1b, the contact pressure and therefore the tightness of the seal can be varied by the length by which the frame parts are moved in the direction 12.1 or 12.2.

In the embodiment according to FIGS. 1a-1c, the collecting feed line 5 and the collecting discharge line 7 are disposed on the same side of the chromatographic module CM.

For a chromatographic apparatus or a module as shown in FIG. 1a, FIG. 1b shows the feed device 1 together with the honeycomb plate 2.1, the discharge device 3 together with the honeycomb plate 2.2 and the plate-shaped porous solid 4 as stationary phase as well as the aforementioned silicone seal 9. As has already been described previously, the feed device 1 is designed in one piece together with the honeycomb plate 2.1. The same applies to the discharge device 3. Further shown is the connector 6.1 of the collecting feed device 5 and the connector 6.2 of the collecting discharge line 7.

Both feed 1 and discharge device 3 are provided with feed 20 or discharge openings 21 in a regular arrangement. The regular arrangement of the discharge openings 21 which applies as a mirror image to the feed openings, is shown for the discharge device 3. The individual feed or discharge openings form cones which overlap as described for FIG. 3g. The discharge line or feed line, which is not shown in the present case, to each feed or discharge opening is provided perpendicular to the surface OF of the porous plate 4. A sieve plate 19 made of titanium is provided in the present case between the feed and discharge device 3, respectively. With the aid of the sieve plate 19 it is possible to set a defined counter-pressure at a specific flow over the entire surface OF of the porous solid 4. The defined counter-pressure at a predefined flow velocity is adjusted by means of the precisely pre-defined perforation 17 of the sieve plate, i.e. the opening diameter. In particular the sieve plate ensures that the same counter-pressure is present over the entire surface. In contrast to this, the porous body has different porosity over the surface OF in the described extent so that the counter-pressure has a certain range of variation over the surface.

The collecting feed or collecting discharge line can be clearly seen in FIG. 1b.

FIG. 1c shows the feed 1 or discharge device 3 once again in more detail. Unlike FIGS. 1a and 1b, in the embodiment in FIG. 1c the feed device 1 and the discharge device 3 are not formed in one piece with the honeycomb-shaped reinforcer plate. The feed device 1 and the discharge device 3 are each by themselves configured in plate shape.

Again shown is the plate-shaped porous solid 4 which serves as the stationary phase for chromatography and the seal 9 surrounding the plate-shaped solid.

The feed device 1 is shown in a plan view. In the plan view of the feed device the dichotomous branching structure of the feed lines 100, 100.1, 100.2 to the feed openings (not shown) can be very clearly identified.

The feed openings are distributed regularly in columns and rows over the entire surface OF of the solid. Due to the regular arrangement in columns and rows of the feed opening, the entire surface OF of the porous solid 4 can be loaded with substance mixture to be separated.

The feed lines to a total of four feed openings should be considered merely as an example. The feed line to two of the four openings 20 is designated by 100.1, the feed line to the further two of the four feed openings is designated by 100.2. As can be seen from FIG. 1c, the length of the lines from the collecting feed line 5 to the respective feed openings 20 is substantially the same. It is thereby achieved that on average substantially the same amount of liquid arrives at all the feed openings over time.

The dichotomous branching structure of the feed plate to the individual feed openings in described in further detail in FIGS. 3a to 3c.

Further shown in a plan view is the discharge device 3 having a plurality of discharge openings 21 arranged regularly in rows and columns. The discharge openings 21 are formed as a mirror image to the feed openings 20 in the feed device, likewise the discharge lines are formed as a mirror image to the feed lines 100, 100.1, 100.2 in the form of a dichotomous branching structure. Each discharge opening is connected via an inlet opening 103 to the discharge line not shown. The discharge line opens through the inlet opening 103 substantially perpendicular to the surface of the porous solid 4 into the discharge opening 21.

FIGS. 2a to 2b show a section through a module according to FIG. 1a to 1c. The cover plates 13, 15 formed as stainless steel plates as well the feed and the discharge device 1.3 with the feed and the discharge openings can be clearly identified. In the present case, the feed openings are configured to be conical without restriction. The feed line to the feed openings opens into the common collecting feed line 5. The collecting feed line common to all discharge openings is designated with 7. The connectors 6.1, 6.2 for the collecting feed and for the collecting discharge line which are each disposed on the same side of the module CM can also be clearly seen in FIG. 2a.

The porous solid as well as the circumferential seal 9 and the frame 11 can furthermore be identified. The seal 9 is characterised in that it has protuberances 9, 9.2 in the direction of the porous solid 4 or the feed 1 or discharge device 3. These protuberances 9.1, 9.2 in the form of a circumferential bulge ensure that the seal 9 is pressed tightly onto the feed or the discharge device. In order to ensure the tightness of the chromatographic apparatus even under pressure, the seal 9 can be additionally pressed by the frame 11.

FIG. 2b shows a detailed view in the area of the seal. The seal 9 is firstly placed around the porous solid 4. Due to the protuberances or bulges 9.1, 9.2, the seal 9 is fixed on the feed device 1 or on the discharge device 3. At the same time the protuberances 9.1, 9.2 are used for sealing. In order to withstand the operating pressure of 3 to 4 bar, the cover plates 13, 15 are screwed and the seal 9 is pressed onto the monolith, i.e. the porous solid.

As in the embodiment according to FIG. 1a-FIG. 1b, the reinforcer plate in honeycomb structure is formed in one piece with the feed device in the present case.

The branching from the collecting feed line 5 to the feed openings 20 is shown in the plan view of the feed plate in FIG. 3a or the detailed views according to FIGS. 3b.1 to 3b.4 and 3c. The plate-shaped discharge device with discharge openings is constructed similarly. The discharge device also has discharge openings which, for example, are configured to be conical (see FIG. 1c). The conical configuration provides a uniform local diversion of the liquid discharged from this opening or a uniform receptacle of the surface of the discharge opening. Conversely the feed openings are also designed to be conical, which ensures a uniform supply over the outlet surface of the feed opening.

FIGS. 3a to 3c show the dichotomous branching structure or the fractal structure of the feed or discharge lines of the feed or discharge device. FIG. 3a shows in plan view a feed plate with 4×16=64 feed openings 20 or discharge openings. The width of the feed plate is designated with x and the length with y. These dimensions correspond to those of the solid matrix 4, for example, in FIGS. 1a to 1c.

Each of these feed 20 or discharge openings is configured to be conical and is supplied with substance mixture to be separated via a feed line 200. FIG. 3a only shows the feed openings 20, 20.1, 20.2, 20.3, 20.4 for some of the feed lines 200. The feed lines 100 from the collecting feed line 5, which opens into a connector (not shown) to the individual feed openings, collecting feed line 5 starting from the collecting feed line 5, a liquid path of equal length is provided to each of the feed openings 20 of the dichotomous branching structure. This is achieved by the dichotomous branching structure or a fractal structure of the feed lines 100 to the individual feed openings 20.

The individual branching points of the dichotomous branching structure for the liquid path from an example feed opening 20.1 as far as the collecting feed line 5 are designated by 22.1, 22.2, 22.3, 22.4, 22.5.

Two feed openings 20.1, 20.2 are assigned to the branching point 22.1. A total of four feed openings are supplied from the branching point 22.2, i.e., 22.1, 22.2, 22.3, 22.4, 8 from the branching point 22.3, 16 from the branching point 22.4, 32 from the branching point 22.5 and finally all 64 feed openings from the collecting feed line 5.

The branches follow a dichotomous branching structure which is also designated as fractal structure. If the four feed openings 20.1, 20.2, 20.3, 20.4 assigned to the branching point 22.2 is considered to be the smallest unit, the feed device with 64 feed openings can be obtained by a simple linear scale-up of the basic pattern 23. Since the geometry of the basic pattern 23 is repeated until the entire surface OF of the solid is covered, in a linear scale-up of the basic pattern to the entire surface in the x and y direction no measurements are required for the entire surface of the solid, rather the parameters for the base body 23 are sufficient. The data for the entire surface OF are then obtained simply by a linear scale-up of the results for the base body 232 to the entire surface.

The dichotomous branching structure shown in FIG. 3a ensures the same liquid path from the collecting feed line 5 to the respective feed openings 20 in each case.

Whereas in the embodiment shown in FIG. 3a, the feed lines 100 to the feed openings 20 open in the respective branching points 22.1, 22.2, 22.3, 22.4, 22.5 substantially at an angle of 90°, FIGS. 3b.1 to 3b.4 show a particularly preferred embodiment in which the branching structure is designed with rounded lines in the area of the branching point 22.1, 22.2, 22.3, 22.4, 22.5, which has the result that the liquid flow is guided to the branching point and in this way turbulence is avoided, whereby a particularly gentle supply to the individual feed openings is accomplished.

In the embodiment according to FIG. 3b.1, as in FIG. 3a, the feed lines 100 open through an outlet opening 104 directed perpendicular to the surface of the plate into the feed opening 20, which is for example configured as a cone.

FIG. 3b.2 shows the liquid flow in the case of a liquid introduced in such a manner perpendicular to the surface OF of the plate-shaped solid 4. As is deduced from FIG. 3b.2, the liquid is not distributed over the entire diameter d_{cone} of the cone but penetrates through the porous solid 4 in the middle of the cone, i.e. directly underneath the outlet opening 104 from which the liquid is supplied. This liquid path is characterised by 106.

In order to avoid such liquid guidance, it can be provided, as shown in FIG. 3b.3 to provide the feed line of the substance mixture to the individual feed openings 20 in conical form from the feed line 100 not perpendicular to the surface OF of the plate-shaped body 4 but substantially horizontally. This is shown in further detail in FIGS. 3n.1 to 3n.2.

The liquid supplied horizontally from the feed line 100 via an outlet opening 104 of the feed opening 20 or the substance mixture impinges against a baffle surface 108, is deflected and is distributed as shown in FIG. 3b.3 over the entire outlet surface 111 of the cone. In this way it is ensured that the entire outlet surface 111 of the cone having the diameter d_{cone,} which comes to rest above the surface OF of the porous solid, is uniformly loaded with liquid. The liquid flow which is deflected and which covers the entire outlet surface 111 is designated with 110. The feed line is designated with 100 as in FIG. 3b.1.

In order to ensure, in addition to the uniform loading by deflection of the liquid flow as shown in FIG. 3b.2, a loading of the individual feed openings 20 which is as uniform as possible in time, in a further developed embodiment it is provided that after the same time, approximately the same amounts of liquid arrive at all feed openings 20 in each case. For this purpose, compared with the embodiment according to FIG. 3b.1, the individual feed lines 100 are optimised in the flow guidance, as shown in FIG. 3b.4 by appropriately thickening or thinning the lines. Such a design with thickened section/thinned sections 118 of the feed lines 100 is shown in FIG. 3b.4. Again the same reference numbers are used for the same components as in FIGS. 3a and 3b.1. The embodiment of the feed lines 100 according to FIG. 3b.4 also corresponds to the dichotomous branching structure shown in FIGS. 3a and 3b.1.

In contrast to the embodiment according to FIG. 3b.1 in which liquid from the feed line was fed through the outlet opening 104 perpendicular to the surface of the plate-shaped solid from above to the feed opening 20, the feed according to the embodiment in FIG. 3b.4 takes place horizontally, as shown in FIG. 3b.3.

The results of experiments for the liquid volume when supplied using an embodiment according to FIG. 3b.1 and FIG. 3b.2 or FIG. 3b.3 and FIG. 3b.3 are shown in FIGS. 3b.5 and 3b.6. For a design with feed lines and feed openings, i.e. supply perpendicular to the surface OF shown according to FIGS. 3b.1 and 3b.2, FIG. 3b.5 shows the amount of liquid which emerges at the respective feed openings measured after the same time. The system according to FIG. 3b5 comprises one such system with 8×8=64 feed openings. As in FIG. 3b.1, the width is designated with x and y. Furthermore, the amount of liquid measured after a predetermined time t, for example, 5 sec, is output. As can be deduced from FIG. 3b.5, the liquid flows substantially very rapidly to the feed openings 22.A, 22.B, 22.C, 22.D located at the edges, in particular at the corners of the feed device, which is why the largest amount of liquid supplied in the same time t is measured at the corners of the feed plate according to FIG. 3b.1. This very non-uniform distribution of the feed device according to FIG. 3b.1 can be made uniform by an improved design of the feed lines in a feed device according to FIG. 3b.4. This is shown in FIG. 3b.6. FIG. 3b.6 in turn shows in a column diagram the amount of liquid which is supplied after a certain time t, for example, 5 seconds, to individual feed openings of the feed device according to FIG. 3b.4. Unlike the column diagram according to FIG. 3b.5, according to FIG. 3b.6 a substantially uniform profile of the amount of liquid is achieved as a result of the hydrodynamically optimised design of the feed lines according to FIG. 3b.4.

In a further embodiment as implemented in FIG. 3c, the feed line 100 already designed in a rounded and therefore a guiding form according to FIG. 3b can be additionally designed with guiding devices, here webs 210. The webs 210 lead to a deflection of a liquid jet impinging upon the web in the direction of a branching. The change of direction induced by the web in the direction of a branching 22 is designated by the reference number 220. The same components as in FIGS. 3a and 3b.1 and 3b.4 are designated with the same reference numbers.

With the aid of the rounding measures and/or with the aid of the guiding devices it is possible that when feeding, for example, at a time t=0 sec, in each case substantially the same amounts of liquid arrive at all the feed openings 20 after the same time, for example, t=5 sec. The effect in the case of guiding devices is similar to or the same as in the case of the thickening or thinning of the feed lines according to FIG. 3b.4. This would not be ensured without the guiding devices and roundings according to the invention. On the contrary, as shown in FIG. 3.b.5, some liquid had already arrived at some feed openings whilst there is no liquid at other feed openings.

The homogenisation in the area of the supply with the aid of roundings and guiding devices, as shown in FIGS. 3b.4 and 3c has the result that at all locations of the porous solid 4, for example, the same amount of substance is chromatographed at the same time.

FIGS. 3d.1 and 3e.1 show the distribution and the temporal evolution of the substance concentration when the solid of the chromatographic apparatus is not uniformly loaded and in the case of largely uniform loading. FIG. 3d.1 shows the solid and at a time t=5 sec, the solid volume of the porous solid 4 penetrated by the liquid. As is deduced from FIG. 3d.1, in the selected example the front portion of the solid is already loaded with liquid (shown by the arrows 230) which has penetrated the porous solid whereas in the rear part no liquid at all has arrived. The local distribution of the substance mixture to be separated over the solid matrix is therefore extremely non-uniform. This means that in the front part 204 of the solid, a separation of the substance mixture is already taking place whereas in the rear part 206 of the solid no liquid has arrived. This can also be deduced from the time profile of the substance concentration over the time or the volume. As shown in FIG. 3e.1, the elution volume is a broad peak.

If on the other hand, according to the invention, a largely uniform supply both in terms of location and temporally is achieved over the entire solid as a result of lines of the same length with the aid of guiding devices and/or thickened sections using an embodiment according to FIG. 3b4 or 3c, as shown in FIG. 3d.2, locally the same amount of liquid is provided for chromatography almost at the same time in the entire solid, i.e., at the same time the same amount of liquid has penetrated the solid 4.

The substance concentration plotted over time or volume according to FIG. 3e.2 is then a very sharp curve, i.e. the substance volume is chromatographed substantially at the same time. In FIGS. 3d2 and 3e2 the same components are characterised with the same reference numbers.

The deviations from an ideal uniform distribution, i.e. the same amount of liquid at all feed openings, when using guiding devices or thickening and thinning of the feed lines from the ideal uniform distribution are merely ±10% preferably less than ±5% as a result of the measures taken (apparatus, guiding device). Without these measures, deviation of ±40% and more would be possible.

FIG. 3f shows in one dimension, here in the x-direction, the ideal uniform distribution and a real distribution of the liquid over the individual feed openings.

FIG. 3g shows a total of four conical feed openings in plan view. The plane of the cones in which the outlet surface 111 lies, that is the diameter d_{cone} is shown. The individual conical feed openings are designated with 20.5, 20.6, 20.7, 20.8. As is deduced from FIG. 3g, the individual cones overlap so that an exchange of liquid from cone to cone is possible. Contact points 340.1, 340.2, 340.3, 340.4 are merely given at the interfaces of the individual cones. Since the volumes V1, V2, V3, V4 of the cones are interconnected and allow an exchange between the cones 22.5, 22.6, 22.7, 22.8, a pressure equalisation over the entire solid surface can be ensured with such an arrangement.

FIGS. 3h.1 to 3h.2 show once again in detail a feed opening 22.9 with the feed line 100 guided horizontally into the feed opening 22.9. The feed opening can have a conical shape but this is not necessarily the case. FIG. 3h1 shows the feed line 100 to the respective feed opening 22.9 and the introduction into the feed opening 22.9. Located opposite the outlet opening 104 is a baffle surface 108 which leads to a deflection of the liquid flow 310 introduced horizontally into the feed opening. This is shown in FIG. 3h.2. The same components as in FIG. 3h.1 are designated with the same reference numbers. The change of direction of the introduced liquid flow 310 and the deflection 320 as a result of the impinging upon the baffle surface 108 is deduced from FIG. 3h.2.

FIG. 4a shows the arrangement of several modules CM according to FIGS. 1 to 3c one above the other in a chromatographic apparatus. The connectors 6.1, 6.2 of the collecting feed 5 and discharge line 7 for each individual one of the modules CM can be clearly identified. These connectors 6.1, 6.2 are disposed on the same side and can, for example, be located in a holding device as shown in FIG. 5, which are connected to a common feed and a common discharge line for all modules.

FIG. 4b shows a section through an arrangement of a plurality of modules located one above the other according to FIG. 4a. In the embodiment according to FIG. 4b each of the modules CM is provided with a wedge surface 411 and with an upper cover 400 and a lower cover 410 for the entire module stack comprising 4 modules CM. Due to the configuration of the individual modules with wedge surfaces 411, it is possible to achieve a clamping effect and therefore a self-clamping of the individual modules stacked one above the other. The modules CM correspond to the configuration as shown in FIGS. 2a to 2b apart from the wedge-shaped configuration of the surfaces 411.

As a result of the wedge-shaped configuration of the surfaces 411 of the individual modules CM it is possible to stack of a plurality of modules (here 4) one above the other in a simple manner without using cover plates which need to be screwed together to achieve a sufficient pressure stability, as in the embodiment according to FIG. 1 or FIG. 2a or 2b.

The wedge-shaped modules are inserted in slide-in modules 413 which also have wedge-shaped surfaces 415. Due to the wedge-shaped configuration of the surfaces 411 and of the modules and of the surfaces 415 of the slide-in modules 413, it is possible for the module to abut flush against the slide-in module surface and thus absorb the high pressures, particularly in the chromatography process without screwing being necessary.

As a result of the wedge-shaped surfaces 411, the module CM can be inserted very easily into the arrangement and removed from it, for example, by releasing the clamping action due to the wedge-shaped surfaces 411, 415, for example, with a spring-assisted ejection.

FIGS. 4c.1 to 4c.4 show stacks of several modules having collecting feed line systems in schematic form, wherein the feed line systems to the individual modules are also designed as dichotomous branches. The system according to FIG. 4c.1 shows a system of two modules CM1, CM2 with a feed line 1000 which branches into two feed lines at the point 2000.1. The system shown in FIG. 4c.2 with 4 modules is constructed similarly, where in turn the collecting feed line 1000 is divided at a total of three branching points 2000.1, 2000.2, 2000.3.

The system having a total of 8 modules according to FIG. 4c.3 has a collecting feed line 1000 to the individual modules and branching points 2000.1, 2000.2, 2000.3, 2000.4, 2000.5, 2000.6, 2000.7.

FIG. 4c.4 shows a system with 16 modules and a dichotomous branched collecting feed line 1000 with branching points 2000.1, 2000.2, 2000.3, 2000.4, 2000.5, 2000.6, 2000.7, 2000.8, 2000.9, 2000.10, 2000.11, 2000.12, 2000.13, 2000.14, 2000.15.

In a particularly preferred embodiment the system having more modules is configured to be mobile, as shown in FIG. 4d. In the system according to FIG. 4d a total of four modules is arranged one above the other and mounted on a mobile substructure 3000. The individual modules CM1, CM2, CM3, CM4 are provided with collecting feed lines 1000 which in turn form a dichotomous branching, and collecting discharge lines 4000 which are also configured as a dichotomous branching. As a result of the arrangement on rollers, the system according to FIG. 4d can easily be moved to different locations.

FIG. 5 shows a holding device for a stationary case of a modularly constructed system. The holding device provides suitable outlets for each individual one of the connectors 6.1, 6.2, the outlets being provided with valves on the holding device so that a pressure-tight and leak-free connection is ensured between the individual modules in the collecting feed or collecting discharge line of the holding device.

In the embodiment according to FIG. 5, the feed or discharge to the individual modules can also comprise dichotomous branches as shown in FIGS. 4c1 to 4c4.

With the invention, a simple structure is provided for the first time whereby the process volume to be treated can be extended simply in a modular manner. The process volume can not only be extended by stacking modules. The invention furthermore enables a so-called linear scale-up in which the number of feed openings can be extended simply, for example, from 4 to 16 or to 64 feed openings without expensive measurements. This is possible because in the system according to the invention, wall effects do not occur when increasing the process volume as in column chromatography. Furthermore the apparatus is characterised by a feed or discharge which for a plurality of feed or discharge openings provides the same line lengths to the respective feed or discharge openings starting from one point.

1-34. (canceled)

35. A module, for the chromatographic separation of a substance mixture in liquid form, comprising:
a stationary phase, said stationary phase being a porous solid plate-shaped body;
at least one feed device having at least one collecting feed line, at least one feed opening and at least one feed line branching into dichotomous branch lines for feeding said substance mixture to said porous solid, said at least one feed opening and at least one feed line being disposed in one plane such that the length of said at least one feed line from said at least one collecting feed line to said at least one feed opening is substantially the same;
a discharge device for discharging an eluate, said discharge device being comprised of at least one collecting discharge line, at least one discharge opening and at least one discharge line branching into dichotomous branch lines;
at least one provided valve; and
said at least one collecting feed line and said at least one collecting discharge feed line being defined to be capable of connecting to said at least one provided valve;
whereby said stationary phase is disposed between said feed device and said discharge device for chromatic separation of a substance mixture in liquid form.

36. The module according to claim 35, said at least one feed line branching into dichotomous branch lines and said at least one discharge line branching into dichotomous branch lines having defined therein guiding devices.

37. The module according to claim 35, said at least one feed opening feeding said substance mixture to said porous solid in a turbulent flow.

38. The module according to claim 35, said at least one feed opening being a conical shape.

39. The module according claim 35, said at least one feed line being substantially horizontal to said plate-shaped body and said at least one feed line leading into at least one feed opening.

40. The module according to claim 35, said at least one feed opening further comprising outlet surfaces arranged so as to substantially cover the entire surface of said porous solid of said stationary phase.

41. (canceled)

42. (canceled)

43. The module according to claim 35, said at least one feed line and said at least one discharge line having the same length.

44. The module according to claim 35, said plate-shaped body having at least one surface and a layer thickness.

45. The module according to claim 44, said plate-shaped body having a thickness in the range between 0.5 to 15 cm.

46. The module according to claim 44, said plate-shaped body having an area in the range of 20 000 cm² to 4 cm².

47. The module according to claim 35, said porous solid selected from a group consisting of:
a polymer material,
a sintered material and
a photonic crystal.

48. The module according to claim 35, said module further including at least one distribution plate, said distribution plate being disposed between said feed device and said discharge device.

49. (canceled)

50. The module according to claim claim 35, said at least one feed opening being a baffled surface.

51. The module according to claim 35, said module comprising a honeycomb plate to reinforce said module.

52. (canceled)

53. (canceled)

54. The module according to claim 35, said at least one feed line and said at least one discharge line having defined therein thickened sections and thinner sections.

55. The module according to claim 35, said module further having at least one wedge-shaped surface defined thereupon.

56. (canceled)

57. The module according to claim 35, said at least one discharge line having attached thereto an assigned sensor.

58. The module according to claim 35, said feed device being selected from a group consisting of:
stainless steel
titanium, and
plastic polymer.

59. A chromatographic apparatus comprising:
at least one module for the chromatographic separation of a substance mixture in liquid form, said at least one module comprising:
a stationary phase, said stationary phase being a porous solid plate-shaped body;
at least one feed device having at least one collecting feed line, at least one feed opening and at least one feed line branching into dichotomous branch lines for feeding said substance mixture to said porous solid, said at least one feed opening and at least one feed line being disposed in one plane such that the length of said at least one feed line from said at least one collecting feed line to said at least one feed opening is substantially the same;
a discharge device for discharging an eluate, said discharge device being comprised of at least one collecting discharge line, at least one discharge opening and at least one discharge line branching into dichotomous branch lines;
at least one provided valve;
said at least one collecting feed line and said at least one collecting discharge feed line being defined to be capable of connecting to said at least one provided valve, whereby said stationary phase is disposed between said feed device and said discharge device for chromatic separation of a substance mixture in liquid form; and
at least one holding device, wherein said holding device includes at least one module feed line, at least one module discharge line, at least one valve for attachment to the at least one collecting feed line and at least one collecting discharge line, respectively, for each of the at least one module.

60. The chromatographic apparatus according to claim 59, said at least one module further having at least one wedge-shaped surface defined thereupon and said holding device further having at least one wedge-shaped surface defined thereupon.

61. A method for manufacturing a device for the chromatic separation of a substance mixture in liquid form, according to claim 1, comprising the following steps:
a provided layer of material, said material being selected from the group consisting of powdered plastic and metal;
selectively fusing and solidifying said material by means of electromagnetic radiation to structure said layer;
applying a new layer to said structured laver;
selectively fusing and solidifying said new layer by means of electromagnetic radiation to structure said new layer;
repeating the application and structuring layers to produce a module having at least one feed opening and at least one discharge opening.

62. The method according to claim 61, wherein said selective fusing and solidification is accomplished with the aid of computer data which characterize said module.

63. The method according to claim 61, wherein said computer data is transmitted by means of a control/regulating unit to a laser which provides said electromagnetic radiation for said selective fusing and solidification.

64. (canceled)

65. The module for the chromatic separation of a substance mixture in liquid form, according to claim 44, said plate-shaped body having a thickness in the range between 1 to 5 cm.

66. The module for the chromatic separation of a substance mixture in liquid form, according to claim 44, said plate-shaped body having an area in the range of 5 000 cm² to 200 cm².

67. The module for the chromatic separation of a substance mixture in liquid form, according to claim 35, said porous solid being comprised of an acrylate.

68. The module for the chromatic separation of a substance mixture in liquid form, according to claim 35, said feed device being selected from a group consisting of stainless steel, titanium, and plastic polymer.
